(19) United States
(12) Patent Application Publication
(10) Pub. No.: US 2004/0236617 A1
(43) Pub. Date: Nov. 25, 2004

(54) System and method for determining a return on investment

(76) Inventor: Peter S. Ebert, Menlo Park, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/441,901

(22) Filed: May 20, 2003

(51) Int. Cl. G06F 17/60

(52) U.S. Cl. 705/7

(57) ABSTRACT

A method and computer program product for determining a return on investment includes determining a total benefit of visibility, determining a total benefit of access, and determining a total cost of ownership.

### RELATED APPLICATIONS

The following applications are hereby incorporated by reference into the subject application as if set forth herein in full: (1) U.S. application Ser. No. 10/136,851, filed Apr. 30, 2002, entitled “Context-Aware and Real-Time Tracking” (Atty. Docket No. 13909-009001); (2) U.S. application Ser. No. 10/136,846, filed Apr. 30, 2002, entitled “Exchange of Article-Based Information Between Multiple Enterprises” (Atty. Docket No. 13909-009002); and (3) U.S. application Ser. No. 10/137,207, filed Apr. 30, 2002, entitled “Bi-Directional Data Flow in a Real Time Tracking System” (Atty. Docket No. 13909-034001).

### BACKGROUND

Since most of the current asset monitoring solutions cannot automatically detect the location or status of assets, business enterprise customers typically depend on error-prone manual or semi-manual processes, which require human input and interaction.

The shortcomings associated with these manual or semi-manual approaches to monitoring assets (i.e., products, merchandise, objects, etc.) are numerous, such as:

(A) businesses cannot uniquely identify assets on an item level;

(B) businesses cannot see where their assets actually are;

(C) businesses do not know the status or condition of their assets;

(D) businesses cannot see the location and telemetry of their assets in real-time;

(E) businesses do not know how or where their assets have been;

(F) businesses do not know how their assets are interacting with other assets and their environment;

(G) the benefit of any existing asset visibility is attenuated by incompatibilities between the various computer systems used by the business, the supplier, and the distributor, for example; and

(H) businesses cannot directly interact with their assets remotely.

Automated asset tracking systems are becoming increasingly important to businesses. By monitoring the location and various variables (e.g., temperature, pressure, humidity, vibration level, etc.) of an asset, various benefits may be realized, such as: reduced shrinkage, increased shipment efficiency, and better detection of accountability for damage and spoilage, for example.

Asset tracking may be accomplished in various ways, such as by attaching tracking tags to the assets being monitored. These tracking tags are typically radio frequency identification (RFID) tags, which may be passive, active, or a hybrid of passive and active.

The monitoring of an asset may occur on as large a basis or as limited a basis as the customer desires. For example, a first customer may choose to only monitor the movement of an asset within a warehouse, while a second customer may choose to monitor an asset from the time it enters their warehouse to the time it is delivered to the end-user. A third customer may choose to monitor an asset from the time it leaves the supplier, through the warehouse distribution phase, and until the product is delivered to the end-user.

When the asset being monitored is merchandise, the size of the unit of merchandise tracked by the customer may be varied in accordance with the desired level of detail. For example, the customer may choose to track merchandise by the pallet, by the case, or by the individual unit. As would be expected, as the size of the unit is decreased (e.g., from a single case to the twelve individual bottles within the single case), the number of tracking tags increases accordingly. Further, as the monitoring system becomes more robust and capable of monitoring the movement of merchandise over a larger area (e.g., across the country versus within a customer's warehouse), the infrastructure cost of the monitoring system increases greatly, as a larger network has to be established to track the movement of merchandise within the area.

Accordingly, prior to a customer committing to the purchase and maintenance of an asset monitoring system, the client will most-likely want to know how much return the customer can reasonably expect from their upfront investment in the system.

### SUMMARY OF THE INVENTION

In one general aspect, a method of determining a return on investment includes determining a total benefit of visibility, determining a total benefit of access, and determining a total cost of ownership.

Implementations may include one or more of the following features. The total benefit of visibility may include one or more of: a unique identity visibility benefit, a location visibility benefit, a telemetry visibility benefit, a real-time visibility benefit, a history visibility benefit, and a context visibility benefit.

The total benefit of visibility, total benefit of access, and total cost of ownership may be determined for a defined interval of time Determining a total benefit of visibility may include summing a plurality of core visibility benefit components to determine an optimum benefit of visibility, determining a leverage factor, and scaling the optimum benefit of visibility by the leverage factor. The plurality of core visibility benefit components may include one or more of: a unique identity visibility benefit, a location visibility benefit, a telemetry benefit, a real-time visibility benefit, a history visibility benefit, and a context visibility benefit. At least one of the core visibility benefit components may be obtained from a potential customer.

Determining a total benefit of access may include determining an optimum benefit of access, determining a leverage factor, and scaling the optimum benefit of access by the leverage factor.

Determining a leverage factor may include determining an integration factor, and determining a dependency factor. Determining a leverage factor may further include dividing the integration factor by the sum of the dependency factor and a leverage unit value (e.g., one).

The total benefit of visibility may be summed with the total benefit of access to determine a total benefit of ownership. The total cost of ownership may be subtracted from the total benefit of ownership to determine an adjusted benefit. This adjusted benefit may be divided by the total cost of ownership.

The above-described method may also be implemented as a sequence of instructions executed by a processor.

The implementations can provide one or more of the following advantages. The return on investment for an asset tracking system can be easily and quickly calculated. By applying standardized formulas, the consistency of ROI calculations can be enhanced. By accounting for internal and external system integration, a more robust ROI calculation can be performed.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a block diagram of an asset monitoring system and the assets being monitored;

FIG. 2 is a block diagram of an ROI determination system;

FIG. 3 is a block diagram of a TBV module of the ROI determination system of FIG. 2;

FIG. 4 is a block diagram of a TBA module of the ROI determination system of FIG. 2; and

FIG. 5 is a block diagram of a TCO module of the ROI determination system of FIG. 2.

### DETAILED DESCRIPTION

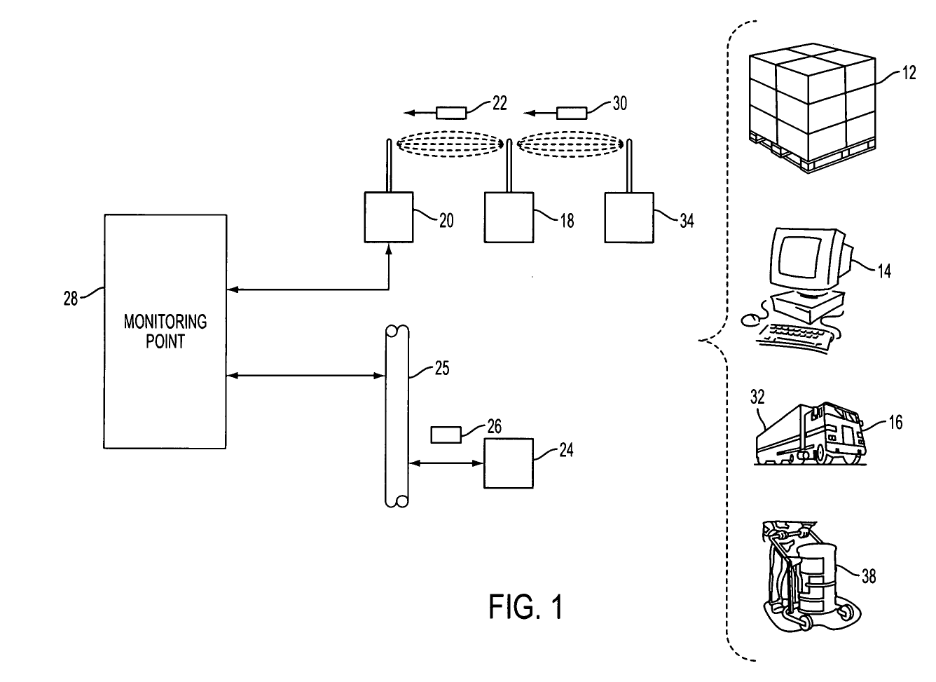

Referring to FIG. 1, various assets 12, 14, and 16 may be monitored to determine their location and status. These assets may include merchandise, corporate equipment, sensitive products, and hazardous goods, for example. The monitoring of these assets is accomplished through the use of various types of monitoring devices/routines (often collectively referred to as “smart items”), in that the specific type of monitoring device/routine depends on the type of asset being monitored.

If the asset being monitored is mobile (e.g., a truck 16 in transit), the monitoring device would ideally need to be a wireless monitoring device. An example of a wireless monitoring device 18 is a radio frequency identification (RFID) tag. These wireless monitoring devices 18, which may be mono-directional or bi-directional communication devices, interact with a remote receiver/transceiver 20 to transmit and receive data 22. Data 22 may include location data, temperature data, humidity data, vibration data, status data, and/or failure data, for example. These wireless monitoring devices 18 may be passive (i.e., never actively transmit data), active (i.e., actively transmit data), or a hybrid passive/active (i.e., only transmits data upon request).

If the asset being monitored is stationary (e.g., computer 14), the monitoring device may be a wired monitoring device 24. For example, if computer 14 is a large mainframe computer and the customer desires to monitor the ambient conditions around the computer, a wired monitoring device 24 may be attached to the computer that includes the requisite sensors for monitoring the relevant ambient conditions. This device is hardwired into the appropriate type of network 25 required to transfer data 26 to a monitoring point 28 specified by the customer. Monitoring point 28 is typically one or more central monitoring stations (not shown) that allow the customer to monitor their assets.

In addition to purely wired devices (i.e., the wired monitoring device 24 used on computer 14) and purely wireless devices (i.e., the wireless monitoring device 18 used on truck 16) discussed so far, other configurations are possible. For example, as discussed above, truck 16 includes a wireless monitoring device 18. This wireless monitoring device 18 may broadcast, among other things, the location information concerning truck 16. This location information may be obtained from a global positioning system (GPS; not shown) incorporated into truck 16 or device 18. As discussed above, in addition to wireless monitoring device 18 being a transmission device, wireless monitoring device 18 is typically also capable of wirelessly receiving data 22 from remote receiver/transceiver 20. Further, wireless monitoring device 18 may also be able to receive data 30 from other devices and retransmit that data 30 to remote receiver/transceiver 20. Therefore, if the merchandise (e.g., pallet of merchandise 12) within the trailer 32 of truck 16 contains a short-range wireless monitoring device 34 that is capable of transmitting data 30 over a limited distance (e.g., a couple of hundred feet), an ad-hoc wireless network between the short-range wireless monitoring device 34 and the longer-range wireless monitoring device 18 of truck 16 may be formed.

This configuration allows relatively short-range wireless monitoring devices 34 to communicate (via a short-range protocol such as IEEE 802.11b or IEEE 802.15.4) with a longer-range wireless monitoring device 18, which is linked to monitoring point 28 with a longer-range protocol such as TCP-IP over a cellular link. Accordingly, an asset monitoring system is created in which the data from many short-range wireless monitoring devices is wirelessly retransmitted to monitoring point 28 using a single longer-range wireless monitoring device 18.

While the system described above uses hardware-based monitoring devices, other configurations are possible, such as software-based routines. For example, since computer 14 is connected to a network-backbone 25, if the customer only wishes to monitor data readily available from the operating system of this computer (e.g., computer status, disk capacity, fault lists, etc.) and this level of monitoring does not require any hardware not already included in the computer (e.g., temperature sensors, humidity sensors, vibration sensors, etc.), a software routine may be used to exploit the existing network hardware and network connection of computer 14 to transmit data to monitoring point 28.

In addition to the commercial uses discussed above, there are other non-commercial uses, such as environmental. For example, wireless monitoring devices may be used to monitor the location and status of hazardous chemicals 38.

While an asset monitoring system can provide a customer with numerous benefits (e.g., reduced lost shipments, increased efficiency, reduced shrinkage, etc.), the startup cost that a customer experiences when first switching to an asset monitoring system are typically quite high. Therefore, it is desirable for the customer to obtain a prediction of the probable return on investment (ROI) that the customer will experience if they acquire the asset monitoring system.

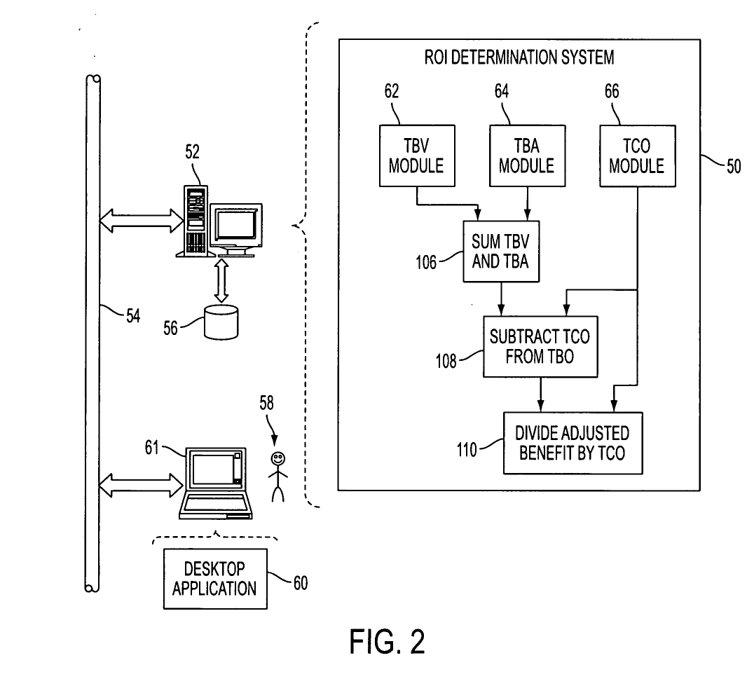

Referring to FIG. 2, there is shown a return on investment (ROI) determination system 50 that allows a user to determine the probable return on investment that will be experienced by a customer that uses an asset tracking system.

ROI determination system 50 typically resides on and is executed by a computer 52 that may be connected to a network 54 (e.g., the Internet, an intranet, a local area network, or some other form of network). The instruction sets and subroutines of ROI determination system 50 are typically stored on a storage device 56 connected to computer 52.

Storage device 56 may be, for example, a hard disk drive, a tape drive, an optical drive, a RAID array, a random access memory (RAM), or a read-only memory (ROM). A user 58 typically accesses, administers, and uses ROI determination system 50 through a desktop application (e.g., Microsoft Internet Explorer™, Netscape Navigator™, or a specialized user interface) running on a computer 61 that is also connected to the network 54.

ROI determination system 50 typically includes three modules, a TBV module 62, a TBA module 64, and a TCO module 66, each of which will be discussed below in detail. The TBV module 62 determines the Total Benefit of Visibility (TBV) for a potential customer, the TBA module 64 determines the Total Benefit of Access (TBA) for the potential customer, and the TCO module 66 determines the Total Cost of Ownership (TCO) for the potential customer. Once these three values (i.e., TBV, TBA, and TCO) are determined, ROI determination system 50 calculates the return on investment using the following formula:

$$ROI [ \% ] = \frac{TBV + TBA - TCO}{TCO} \times 100 \qquad [ F1 ]$$

with ROI=Return on Investment

TBV=Total Benefit of Visibility

TBA=Total Benefit of Access

TCO=Total Cost of Ownership

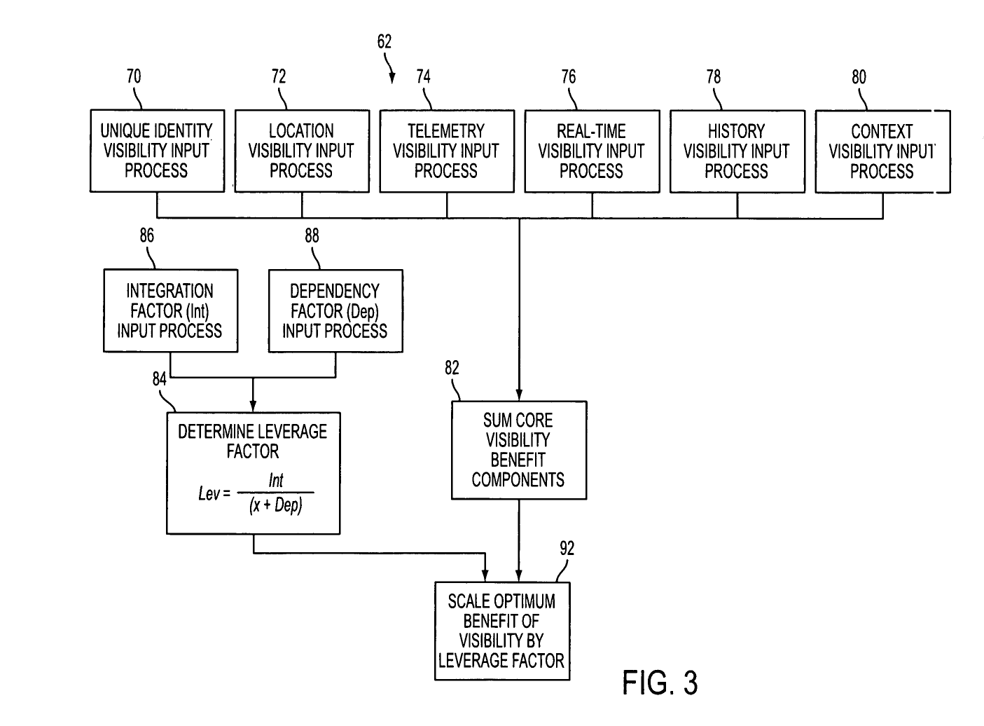

Referring to FIG. 3, TBV module 62 calculates the total benefit of visibility (TBV) for a potential customer. This is the value realized by the customer due to the customer being able to track their assets. Typically, the total benefit of visibility is determined in accordance with the following formula:

TBV[$]=(U_{VisB}+L_{VisB}+T_{VisB}+R_{VisB}+H_{VisB}+C_{VisB})×Lev [F2]

with U_{VisB}=Unique Identity Visibility Benefit, which addresses Shortcoming A described above.

L_{VisB}=Location Visibility Benefit, which addresses Shortcoming B described above.

T_{VisB}=Telemetry Visibility Benefit, which addresses Shortcoming C described above.

R_{VisB}=Real-Time Visibility Benefit, which addresses Shortcoming D described above.

H_{VisB}=History Visibility Benefit, which addresses Shortcoming E described above.

C_{VisB}=Context Visibility Benefit, which addresses Shortcoming F described above.

Lev=Leverage Factor, which applies a value to Shortcoming G described above.

U_{VisB}, L_{VisB}, T_{VisB}, R_{VisB}, H_{VisB}, and C_{VisB} are referred to as core visibility benefit components and are defined as the estimated monetary benefits that a potential customer will realize if the specific class of visibility is provided. The value of these core visibility benefit components is assigned by either the user of ROI determination system 50 or the potential customer.

The unique identity visibility benefit (U_{VisB}) represents the benefit (in dollars) that a potential customer will realize if that potential customer is able to uniquely identify each of their assets. For example, if the potential customer sells laptop computers, it would be beneficial for the potential customer to place a wireless monitoring device onto each of the critical components of the laptop. Therefore, if the laptop is returned for a warranty repair, the potential customer can quickly determine if any of those critical components were changed or replaced by the purchaser of the laptop. TBV module 62 includes a unique identity visibility benefit input process 70 that allows a user to specify a value for U_{VisB}.

The location visibility benefit (L_{VisB}) represents the benefit (in dollars) that a potential customer will realize if that potential customer is able to locate each of their assets. For example, if the potential customer is a package courier, it would be beneficial for the potential customer to be able to quickly determine the location of the individual packages they are delivering. TBV module 62 includes a location visibility benefit input process 72 that allows a user to specify a value for L_{VisB}.

The telemetry visibility benefit (T_{VisB}) represents the benefit (in dollars) that a potential customer will realize if that potential customer is able to monitor various variables concerning their assets. For example, if the potential customer is a shipping company that ships perishable products (e.g., diary products, seafood, produce, etc.), it would be beneficial for the potential customer to be able to monitor temperature of these products, and the level of humidity surrounding these products. Further, if the potential customer ships electronics, it may be beneficial for the potential customer to monitor the level of vibration to which their products are exposed. TBV module 62 includes a telemetry visibility benefit input process 74 that allows a user to specify a value for T_{VisB}.

The real-time visibility benefit (R_{VisB}) represents the benefit (in dollars) that a potential customer will realize if that potential customer is able to locate, receive and monitor data from their assets in real-time or near real-time. The frequency that the monitoring devices transmit the data can be varied to regulate power consumption. For example, while a monitoring device that continuously transmits data provides the most up-to-date data to the potential customer, power consumed by the monitoring device tends to be quite high. Accordingly, a predefined reporting frequency may be established so that the monitoring device only transmits data every three hours, for example. Alternatively, an acceptable range of values (e.g., a temperature range) may be established for the variable being monitored, and if the monitored variable falls outside of that acceptable range, data (e.g., an alarm) may immediately be transmitted. TBV module 62 includes a real-time visibility benefit input process 76 that allows a user to specify a value for R_{VisB}.

The history visibility benefit (H_{VisB}) represents the benefit that a potential customer will realize if that potential customer has an historical record concerning variables monitored for an asset. For example, if a monitoring device is attached to an asset and is recording data including location, temperature, and humidity information, this data may be time stamped when it is stored so that a historical record can be established for the asset being monitored. The historical record may for example be used to identify when and where a monitored asset was damaged in order to identify a liable party.

While this historical data is discussed as being stored locally, other configurations are possible. For example, as stated above, a monitoring device may be configured to transmit data every three hours. Accordingly it is possible for monitoring point 28 (See FIG. 1) to time stamp and store the data transmitted by the monitoring device, thus establishing a remote historical record. TBV module 62 includes a history visibility benefit input process 78 that allows a user to specify a value for H_{VisB}.

The context visibility benefit (C_{VisB}) represents the benefit that a potential customer will realize if that potential customer is able to monitor the interaction of various assets. For example, there are certain chemical products whose interaction could have problematic results, such as chlorine bleach and ammonia. Accordingly, if the potential customer is a chemical distributor and the assets monitored are the shipments of chemical products, it may be desirable to limit the potential for interaction between the chemical products having known undesirable interaction characteristics. Accordingly, the customer may monitor the location of these chemical products and trigger an alarm if the two “incompatible” products are within a defined range. TBV module 62 includes a context visibility benefit input process 80 that allows a user to specify a value for C_{VisB}.

While there are six core visibility benefit components described above, a potential customer may not realize a benefit from each of the components. Accordingly, the value associated with one or more of these components may be zero.

Once a value is established for each of the core visibility benefit components (i.e., U_{VisB}, L_{VisB}, T_{VisB}, R_{VisB}, H_{VisB}, and C_{VisB}), the TBV module 62 sums 82 of the core visibility benefit components to determine an optimum benefit of visibility.

TBV module 62 also determines 84 a leverage factor for the potential customer. The leverage factor is a unit-less multiplier that expresses the estimated grade of integration of the proposed asset monitoring system with the related business processes and enterprise applications currently being used (or planned on being used) by the potential customer. This leverage factor also takes into account the level of dependency that the potential customer has on external partners, as the inability to integrate the proposed asset monitoring system with the business processes and enterprise applications of critical external partners impacts the total level of integration of the system. The leverage factor is determined as follows:

$$Lev = \frac{Int}{( x + Dep )} \qquad [ F3 ]$$

with Lev=Leverage Factor

Int=Integration Factor

Dep=Dependency Factor

x=a leverage unit value, typically 1

The integration factor (i.e., “Int”) defines the level of integration with the related business processes and enterprise applications of the potential customer. The value of the integration factor ranges from 0 (i.e., 0% integration) to 1 (i.e., 100% integration). TBV module 62 includes an integration factor input process 86 that allows a user to specify a value for the integration factor.

The dependency factor (i.e., “Dep”) is a measure of the constraints imposed due to the dependency of the potential customer on external business partners and regulations. For example, for a large distribution network that requires a lot of system integration and standards agreement between the potential customer and their partners, the value of the dependency factor is quite high. An example of such a scenario is an asset monitoring system that monitors: the delivery of raw material (from suppliers) to the potential customer's factory; the conversion of those raw materials into a finished product; and the transport of the finished product to an end-user.

A scenario in which the value of the dependency factor is quite low is when the potential customer essentially does not depend on external business partners. An example of such a scenario is a potential customer who is considering the purchase of an asset monitoring system to monitor the location and telemetry of various assets within the factories owned by the potential customer.

The value of the dependency factor ranges from 0 (i.e., 0% dependence on external partners) to infinity (i.e., 100% dependence on external partners). TBV module 62 includes a dependency factor input process 88 that allows a user to specify a value for the dependency factor.

Once the integration factor and dependency factor are specified, the leverage factor is calculated by TBV module 62 in accordance with formula F3. Therefore, TBV module 62 divides the values of the integration factor by the sum of the dependency factor and the leverage unit value (which is typically 1).

The TBV module 62 then (pursuant to formula F2) scales 92 the optimum benefit of visibility by the leverage factor to determine the total benefit of visibility (TBV).

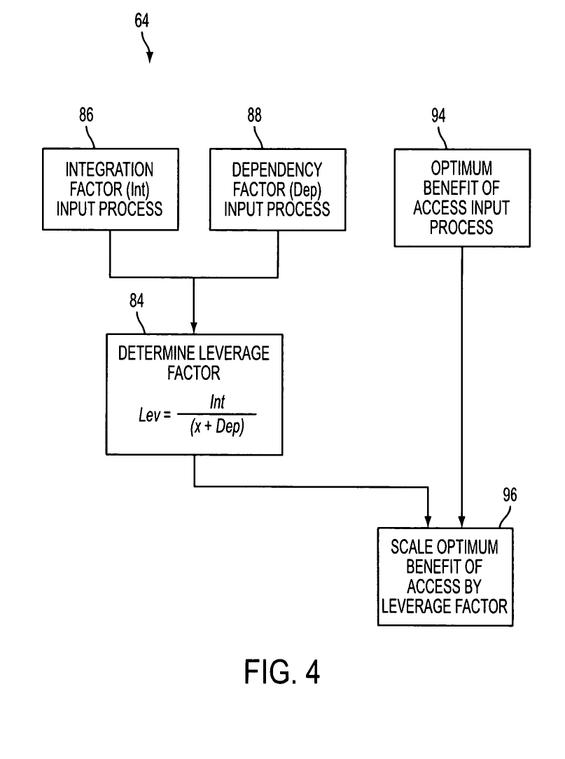

Referring to FIG. 4, TBA module 64 calculates the total benefit of access (TBA) for a potential customer. This value represents the benefit (in dollars) that the potential customer will realize if they are not only able to access data from an asset, but also able to make adjustments to that asset. Typically, the total benefit of access is determined in accordance with the following formula:

TBA[$]=A_{B}×Lev [F4]

with TBA=Total Benefit of Access.

A_{B}=Optimum Benefit of Access, which addresses Shortcoming H.

Lev=Leverage Factor.

The optimum benefit of access (A_{B}) represents the benefit (in dollars) that a potential customer will realize if that potential customer is able to remotely access various assets. For example, a potential customer may use a monitoring device to monitor the temperature of a fluid leaving a mixing value that mixes a hotter fluid with a cooler fluid. The potential customer may receive periodic data from the monitoring device that indicates the temperature of the fluid mixture. In the event that the fluid mixture is out of range (i.e., too hot or too cold), the mixing value can be adjusted to bring the temperature of the fluid mixture back into range. TBA module 64 includes an optimum benefit of access input process 94 that allows a user to specify a value for A_{B}.

The leverage factor (“Lev”) of Formula F4 is calculated in the same fashion as the leverage factor for Formula F2 (i.e., using the leverage factor Formula F3). Typically, the value of the leverage factors for Formulas F2 and F4 are the same unless, for example, technological issues make bidirectional communication (required to achieve the benefit of access) more difficult than mono-directional communication.

Once the leverage factor is determined, the TBA module 64 (pursuant to formula F4) scales 96 the optimum benefit of access by the leverage factor to determine the total benefit of access (TBA).

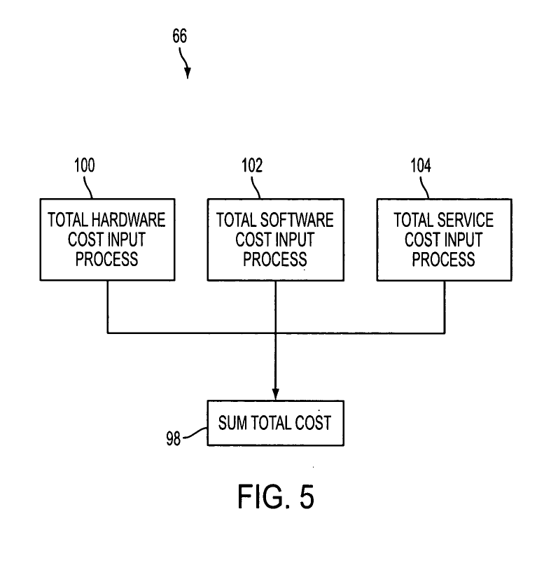

Referring to FIG. 5, TCO module 66 determines the total cost of ownership (TCO) for a potential customer according to the following formula:

TCO[$]=HardwareCost+SoftwareCost+ServicesCost [F5]

When calculating the total cost of ownership, TCO module 66 sums 98 the following: the hardware costs representative of the upfront and ongoing cost of the hardware required for the asset monitoring system; the software costs representative of the upfront and ongoing cost of the software required for the asset monitoring system; and the service costs representative of the upfront and ongoing cost of setting up and servicing the asset monitoring system. The total cost of ownership represents all scenario-specific incurred costs such as: original equipment; software purchase; system deployment; user training; salaries of support staff; system maintenance; troubleshooting; support; productivity loss during the previous processes; and the cost of administrative tools, for example. TCO module 66 includes a hardware cost input process 100, a software cost input process 102, and a service cost input process 104 that allow a user to specify a value for the factors.

As discussed above, the total benefit of visibility (TBV), total benefit of access (TBA), and total cost of ownership (TCO) have been calculated. Accordingly, ROI determination system 50 determines (using Formula 1) the probable return on investment that will be experienced by a customer that incorporates an asset tracking system. Therefore, referring again to FIG. 2, ROI determination system 50 sums 106 the total benefit of visibility (TBV) and the total benefit of access (TBA) to determine a total benefit of ownership. ROI determination system 50 then subtracts 108 the total cost of ownership (TCO) from the total benefit of ownership to determine an adjusted benefit. ROI determination system 50 then divides 110 the adjusted benefit by the total cost of ownership (TCO) to determine the return on investment (ROI).

As the below example illustrates, the above described calculations are typically performed with respect to defined time periods. This allows the potential customer to more fully appreciate the ramp-up time associated with actually receiving a return on their investment and the cash flows required to achieve that return on investment. Accordingly, by introducing a time factor into Formula F1, the following time-dependant formula is derived:

$$ROI ( t ) [ \% ] = \frac{TBV ( t ) + TBA ( t ) - TCO ( t )}{TCO ( t )} \times 100 \qquad [ F6 ]$$

Calculating the return on investment using Formula F6 is essentially the same as calculating the return on investment using Formula F1. The only difference is that the values of TBV, TBA and TCO are all calculated for a defined interval of time, as opposed to over the entire lifespan of the system. Therefore, if the user wanted to determine the return on investment for the first quarter of a fiscal year, the user would derive the values of TBV, TBA and TCO based on that same interval of time.

The following table shows a typical report that would be prepared by a user of ROI determination system 50 for a potential customer (i.e., an oil and gas company). The report shows the benefits and costs (in $1,000 units) that a customer will most like experience. The report is broken down along the top row into four yearly quarters (i.e., Q1, Q2, Q3, and Q4). In the first column, the report is divided into several portions, including a Visibility Benefits portion, an Access Benefits portion, and a Leverage Factor portion. The Visibility Benefits portion breaks down the visibility benefit into the six visibility benefit components, namely U_{VisB}, L_{VisB}, T_{VisB}, R_{VisB}, H_{VisB}, and C_{VisB}.

| | | | | | | Total |
|---|---|---|---|---|---|---|
| | | Q1 | Q2 | Q3 | Q4 | Year 1 |
| Visibility | U | $90 | $110 | $100 | $120 | |
| Benefits | L | $200 | $300 | $200 | $140 | |
| | T | $150 | $200 | $160 | $160 | |
| | R | $110 | $130 | $110 | $100 | |
| | H | $140 | $150 | $160 | $165 | |
| | C | $60 | $120 | $70 | $60 | |
| Access | A | $200 | $200 | $200 | $200 | |
| Benefit | Int | 0.10 | 0.20 | 0.30 | 0.40 | |
| | Dep | 0.00 | 0.00 | 0.00 | 0.00 | |
| Leverage | Lev | 0.10 | 0.20 | 0.30 | 0.40 | |
| Factor | TBV | $95 | $242 | $300 | $378 | $1,015 |
| | TCO | $500 | $100 | $100 | $100 | $800 |
| | ROI | −81.00% | −43.83% | −9.00% | 26.88% | 26.88% |

After selecting the time intervals for the report, the customer is asked to provide estimated monetary benefits for each of the above defined core visibility benefit components for the selected time intervals. For example, by gaining unique identification of each tracked item, the customer estimates that $90,000 can be saved within the first quarter (i.e., Q1) after deploying the asset monitoring system. These saving could, for example, stem from the ability to recall specific products very easily and cost efficiently.

In addition, the customer and the user of the ROI determination system 50 will estimate appropriate factors for Integration “Int” and Dependencies “Dep” based on the specific business processes and enterprise applications of the potential customer and external business partners for the chosen intervals of time. For example, since the defined scenario is an in-house asset tracking scenario that does not depend on external partners, “Dep” is chosen to be 0.

Finally, the user of the ROI determination system 50 estimates the TCO of the asset monitoring system for the selected time period. For example, the first deployment in Q1 will need to include hardware costs (TCO_{Q1}=$500,000) while the following quarters will only need to include system maintenance and license costs (TCO_{Q2,Q3,Q4}=$100,000).

While the costs and benefits described above are stated in U.S. dollars, the above-described system and method is not currency specific and is applicable to any currency.

The system and method described herein is not limited to the implementation described above; it may find applicability in any computing or processing environment. The system and method may be implemented in hardware, software, or a combination of the two. For example, the system and method may be implemented using circuitry, such as one or more of programmable logic (e.g., an ASIC), logic gates, a processor, and a memory.

The system and method may be implemented in computer programs executing on programmable computers that each includes a processor and a storage medium readable by the processor (including volatile and non-volatile memory and/or storage elements). Each such program may be implemented in a high-level procedural or object-oriented programming language to communicate with a computer system and method. However, the programs can be implemented in assembly or machine language. The language may be a compiled or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the data framer interface. The system and method may also be implemented as a machine-readable storage medium, configured with a computer program, where, upon execution, instructions in the computer program cause a machine to operate to perform the functions of the system and method described above.

Implementations of the system and method may be used in a variety of applications. Although the system and method is not limited in this respect, the system and method may be implemented with memory devices in microcontrollers, general-purpose microprocessors, digital signal processors (DSPs), reduced instruction-set computing (RISC), and complex instruction-set computing (CISC), among other electronic components.

Implementations of the system and method may also use integrated circuit blocks referred to as main memory, cache memory, or other types of memory that store electronic instructions to be executed by a microprocessor or store data that may be used in arithmetic operations.

Additionally, implementations of the system and method described above need not be performed by a computer and/or computing device and may be performed manually using standard arithmetic processes and procedures.

A number of implementations have been described. Nevertheless, it will be understood that various modifications may be made. Accordingly, other implementations are within the scope of the following claims.

What is claimed is:

1. A method of determining a return on investment comprising:
determining a total benefit of visibility;
determining a total benefit of access; and
determining a total cost of ownership.

2. The method of claim 1 wherein the total benefit of visibility includes a unique identity visibility benefit.

3. The method of claim 1 wherein the total benefit of visibility includes a location visibility benefit.

4. The method of claim 1 wherein the total benefit of visibility includes a telemetry visibility benefit.

5. The method of claim 1 wherein the total benefit of visibility includes a real-time visibility benefit.

6. The method of claim 1 wherein the total benefit of visibility includes a history visibility benefit.

7. The method of claim 1 wherein the total benefit of visibility includes a context visibility benefit.

8. The method of claim 1 wherein the total benefit of visibility, total benefit of access, and total cost of ownership are determined for a defined interval of time.

9. The method of claim 1 wherein determining a total benefit of visibility includes:
summing a plurality of core visibility benefit components to determine an optimum benefit of visibility;
determining a leverage factor; and
scaling the optimum benefit of visibility by the leverage factor.

10. The method of claim 9 wherein the plurality of core visibility benefit components include one or more of: a unique identity visibility benefit; a location visibility benefit; a telemetry visibility benefit; a real-time visibility benefit; a history visibility benefit; and a context visibility benefit.

11. The method of claim 9 wherein at least one of the plurality of core visibility benefit components is obtained from a potential customer.

12. The method of claim 9 wherein determining a leverage factor includes:
determining an integration factor; and
determining a dependency factor.

13. The method of claim 12 wherein determining a leverage factor further includes dividing the integration factor by the sum of the dependency factor and a leverage unit value.

14. The method of claim 13 wherein the leverage unit value is one.

15. The method of claim 1 wherein determining a total benefit of access includes:
determining an optimum benefit of access;
determining a leverage factor; and
scaling the optimum benefit of access by the leverage factor.

16. The method of claim 15 wherein determining a leverage factor includes:
determining an integration factor; and
determining a dependency factor.

17. The method of claim 16 wherein determining a leverage factor further includes dividing the integration factor by the sum of the dependency factor and a leverage unit value.

18. The method of claim 16 wherein the leverage unit value is one.

19. The method of claim 1 further comprising:
summing the total benefit of visibility with the total benefit of access to determine a total benefit of ownership; and
subtracting the total cost of ownership from the total benefit of ownership to determine an adjusted benefit; and
dividing the adjusted benefit by the total cost of ownership.

20. A computer program product residing on a computer readable medium having a plurality of instructions stored thereon which, when executed by the processor, cause that processor to:
determine a total benefit of visibility;
determine a total benefit of access; and
determine a total cost of ownership.

21. The computer program product of claim 20 wherein the total benefit of visibility includes a unique identity visibility benefit.

22. The computer program product of claim 20 wherein the total benefit of visibility includes a location visibility benefit.

23. The computer program product of claim 20 wherein the total benefit of visibility includes a telemetry visibility benefit.

24. The computer program product of claim 20 wherein the total benefit of visibility includes a real-time visibility benefit.

25. The computer program product of claim 20 wherein the total benefit of visibility includes a history visibility benefit.

26. The computer program product of claim 20 wherein the total benefit of visibility includes a context visibility benefit.

27. The computer program product of claim 20 wherein the total benefit of visibility, total benefit of access, and total cost of ownership are determined for a defined interval of time.

28. The computer program product of claim 20 wherein the instructions for determining a total benefit of visibility include instructions for:
summing a plurality of core visibility benefit components to determine an optimum benefit of visibility;
determining a leverage factor; and
scaling the optimum benefit of visibility by the leverage factor.

29. The computer program product of claim 28 wherein the plurality of core visibility benefit components include one or more of: a unique identity visibility benefit; a location visibility benefit; a telemetry visibility benefit; a real-time visibility benefit; a history visibility benefit; and a context visibility benefit.

30. The computer program product of claim 28 wherein at least one of the plurality of core visibility benefit components is obtained from a potential customer.

31. The computer program product of claim 28 wherein the instructions for determining a leverage factor include instructions for:
determining an integration factor; and
determining a dependency factor.

32. The computer program product of claim 31 wherein the instructions for determining a leverage factor further include instructions for dividing the integration factor by the sum of the dependency factor and a leverage unit value.

33. The computer program product of claim 32 wherein the leverage unit value is one.

34. The computer program product of claim 20 wherein the instructions for determining a total benefit of access include instructions for:
determining an optimum benefit of access;
determining a leverage factor; and
scaling the optimum benefit of access by the leverage factor.

35. The computer program product of claim 34 wherein the instructions for determining a leverage factor include instructions for:
determining an integration factor; and
determining a dependency factor.

36. The computer program product of claim 35 wherein the instructions for determining a leverage factor further include instructions for dividing the integration factor by the sum of the dependency factor and a leverage unit value.

37. The computer program product of claim 36 wherein the leverage unit value is one.

38. The computer program product of claim 20 further comprising instructions for:
summing the total benefit of visibility with the total benefit of access to determine a total benefit of ownership; and
subtracting the total cost of ownership from the total benefit of ownership to determine an adjusted benefit; and
dividing the adjusted benefit by the total cost of ownership.
